(19) United States
(12) Patent Application Publication
(10) Pub. No.: US 2018/0357135 A1
(43) Pub. Date: Dec. 13, 2018

(54) INFORMATION PROCESSING APPARATUS THAT MANAGES DATA ON CLIENT, BACKUP METHOD THEREFOR, CONTROL METHOD THEREFOR, AND STORAGE MEDIUM

(71) Applicant: CANON KABUSHIKI KAISHA, Tokyo (JP)

(72) Inventor: Toru Yoshida, Tokyo (JP)

(21) Appl. No.: 16/105,091

(22) Filed: Aug. 20, 2018

Related U.S. Application Data
(63) Continuation of application No. PCT/JP2017/005030, filed on Feb. 7, 2017.

(30) Foreign Application Priority Data
Feb. 24, 2016 (JP) 2016-033488

(51) Int. Cl. G06F 11/14

(52) U.S. Cl. CPC G06F 11/1464; G06F 11/1461

(57) ABSTRACT

An information processing apparatus which enables continuous use of data managed by a server integrated with a client. The information processing apparatus receives, from one client of a plurality of clients, a registration request that requests to register the one client as a management target for the server. The information processing apparatus determines whether or not the one client that has issued the registration request is a client corresponding to a client application stored in a storage. The information processing apparatus sets the one client as a backup destination of accumulated data, in a case where the backup destination has not been set and it is determined that the one client is not the client corresponding to the client application stored in the storage.

### CROSS-REFERENCE TO RELATED APPLICATIONS

This application is a Continuation of International Patent Application No. PCT/JP2017/005030, filed Feb. 7, 2017, which claims the benefit of Japanese Patent Application No. 2016-033488, filed Feb. 24, 2016, both of which are hereby incorporated by reference herein in their entirety.

### BACKGROUND OF THE INVENTION

### Field of the Invention

The present invention relates to an information processing apparatus, a backup method therefor, a control method therefor, and a storage medium.

### Background Art

There is known a server-client system in which a server stores and manages setting data on an MFP which is a client. The setting data is synchronized between the server and the MFP. For example, when the setting data stored in the server is changed, the server sends the changed setting data to the MFP. Also, when the setting data stored in the MFP is changed, the MFP sends the changed setting data to the server (see, for example, PTL (Patent Literature) 1). As a result, the setting data is available in the state of being synchronized between the server and the MFP. When a plurality of MFPs is connected to the server, the server manages setting data on each of the MFPs.

In response to an instruction to perform backup of setting data that is an object to be managed (hereafter referred to as “management target setting data”), the server selects a backup destination of management target setting data, which the server holds, from among a plurality of MFPs which are clients (see, for example, PTL 2).

There is also conventionally known an arrangement in which one MFP functions as a server and functions as a client (see, for example, PTL 3).

### CITATION LIST

### Patent Literature

PTL 1 Japanese Laid-Open Patent Publication (Kokai) No. 2015-121989

PTL 2 Japanese Laid-Open Patent Publication (Kokai) No. 2008-83942

PTL 3 Japanese Laid-Open Patent Publication (Kokai) No. 2010-283618

In the prior arts, however, no consideration is given to a case where one MFP, which plays a role as a server in a system, acts as a server and also as a client. For example, no consideration is given to a backup process carried out in a case where one MFP has both a server application for implementing a server function and a client application for implementing a client function, and these applications are running at the same time. When one MFP acts as a server and a client, problems described hereafter arise.

Specifically, a server selects a backup destination from among a plurality of clients which the server itself manages. Here, the clients which the server manages include not only other devices but also a client implemented by a client application of the server itself. The server selects a backup destination from among the client of the server itself and other devices. Here, if the server selects the client of the server itself as a backup destination, a problem arises because backup data cannot be used when the backup data should be used.

For example, when the server is disconnected from a network due to maintenance, or the entire server stops operating due to failure, the client of the server itself is also disconnected from the network or stops operating. Therefore, if management target setting data is backed up to the client operating on the same device as the server, backup data cannot be used when the server cannot be used.

Backup data is used for the purpose of continuously operating the system using the backup data even when the server is temporarily unavailable due to failure or maintenance. However, in the above described case, when the server cannot be used, backup data cannot be used either, making continuous operation of the system impossible.

### SUMMARY OF THE INVENTION

The present invention provides an information processing apparatus which enables continuous use of data managed by a server integrated with a client, a backup method therefor, a control method therefor and a storage medium.

Accordingly, the present invention provides an information processing apparatus acting as a server that manages data on a plurality of clients, comprising, a storage storing a server application for the server and a client application for a client, a memory storing instructions related to the server application, and a processor executing the instructions causing the information processing apparatus to receive, from one client of the plurality of clients, a registration request that requests to register the one client as a management target for the server, transmit, to the one client, a response for the registration, accumulate data received from the one client as the management target, determine whether or not the one client that has issued the registration request is a client corresponding to the client application stored in said storage, and set the one client as a backup destination of the accumulated data, in a case where the backup destination has not been set and it is determined that the one client is not the client corresponding to the client application stored in said storage.

Further features of the present invention will become apparent from the following description of exemplary embodiments (with reference to the attached drawings).

### BRIEF DESCRIPTION OF THE DRAWINGS

FIG. 1 is a configuration diagram schematically showing a configuration of a communication system including an MFP which is an information processing apparatus according to an embodiment of the present invention.

FIG. 2 is a block diagram schematically showing a configuration of hardware in an MFP server in FIG. 1.

FIG. 3 is a block diagram schematically showing a configuration of software modules of the MFP server in FIG. 1.

FIG. 4 is a block diagram schematically showing a configuration of software modules in the MFP in FIG. 1.

FIG. 5 is a flowchart showing the procedure of a registration requesting process which is carried out by the MFP in FIG. 1.

FIG. 6 is a flowchart showing the procedure of a registration process which is carried out by the MFP server in FIG. 1.

FIG. 7 is a flowchart showing the procedure of a backup destination setting process in step S609 in FIG. 6.

FIG. 8 is a flowchart showing the procedure of an acceptability determination process which is carried out by the MFP in FIG. 1.

FIG. 9 is a view showing an exemplary setting screen displayed on an operating unit of the MFP in FIG. 1.

FIG. 10 is a flowchart showing the procedure of a replacement request receiving process which is carried out by the MFP in FIG. 1.

FIG. 11 is a view showing an exemplary setting screen displayed on the operating unit of the MFP in FIG. 1.

FIG. 12 is a flowchart showing the procedure of a replacement termination receiving process which is carried out by the MFP in FIG. 1.

FIG. 13 is a view showing an exemplary setting screen displayed on the operating unit of the MFP server in FIG. 1.

FIG. 14 is a flowchart showing the procedure of a backup termination process which is carried out by the MFP server in FIG. 1.

FIG. 15 is a flowchart showing the procedure of a termination notification receiving process which is carried out by the MFP in FIG. 1.

FIG. 16 is a flowchart showing the procedure of a variation of the backup destination setting process in FIG. 7.

FIG. 17 is a flowchart showing the procedure of a regular backup process in FIG. 7 which is carried out by the MFP server in FIG. 1.

### DESCRIPTION OF THE EMBODIMENTS

Hereafter, a first embodiment of the present invention will be described in detail with reference to the drawings.

In the present embodiment described hereafter, the present invention is applied to an MFP (multifunction peripheral) which is an information processing apparatus, but the present invention should not necessarily be applied to the MFP. For example, the present invention may be applied to an SFP (single-function peripheral) with limited functions or any other apparatuses such as a PC as long as they have a server function. Moreover, in the present embodiment described hereafter, the present invention is applied to an MFP which is a client apparatus, but the present invention should not necessarily be applied to the MFP. For example, the present invention may be applied to an SFP or any other apparatuses such as a PC as long as they have a client function.

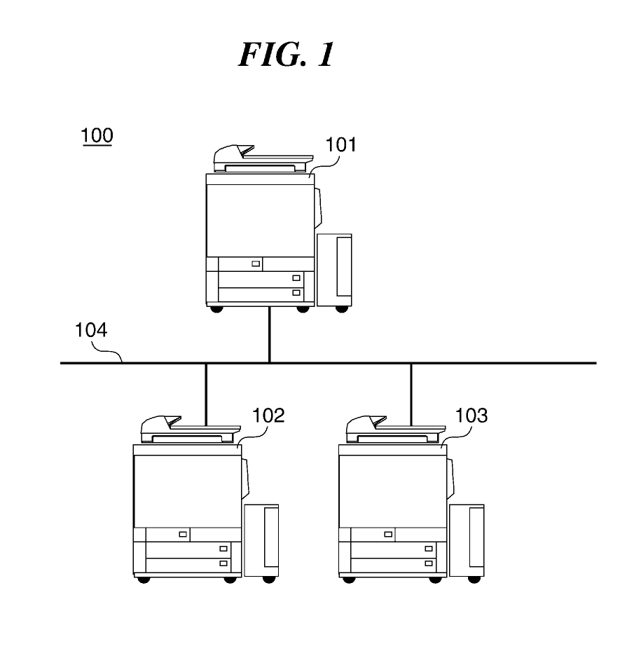

FIG. 1 is a configuration diagram schematically showing a configuration of a communication system 100 including an MFP 101 which is an information processing apparatus according to the embodiment of the present invention.

Referring to FIG. 1, the communication system 100 has the MFP 101 which acts a server (hereafter referred to as “the MFP server 101”), and MFPs 102 and 103 which have a client function. The MFP server 101 and the MFPs 102 and 103 are connected to one another via a network 104.

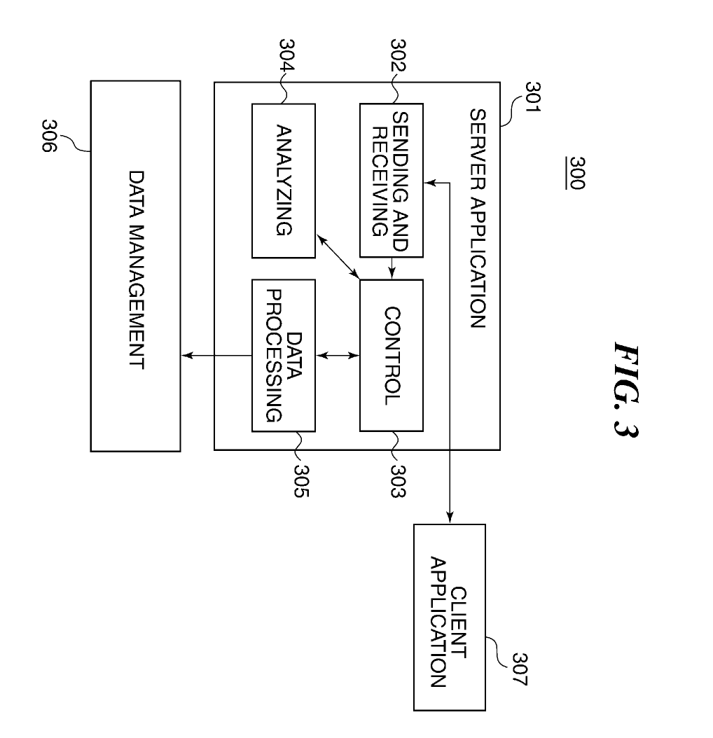

The MFP server 101 has a server application 301 in FIG. 3, to be described later, which is for implementing a server function, and stores and manages setting data for use in the MFPs 102 and 103 registered as management target apparatuses. The MFP server 101 also has client applications 307 in FIG. 3, to be described later, which is for implementing a client function. The MFP server 101 manages setting data on the MFP 101 itself, which is a client, as well.

The server application 301 of the MFP 101 manages a master database. The client applications 307 of the MFP 101 manage databases including setting data that is for the MFP 101 to carry out a printing process, a scanning process, and so forth. The master database and the databases managed by the respective client applications 307 are synchronized with each other.

For example, when setting data on the MFP 102 included in the master database of the MFP server 101 is changed, the MFP server 101 sends the changed setting data on the MFP 102 to the MFP 102 and the MFP 103. The MFP 102 and the MFP 103 update their databases, which are managed by their own client applications 307, with the setting data received from the MFP server 101.

Also, when setting data included in the database in the MFP 102 is changed, the MFP 102 sends the changed setting data to the MFP server 101. The MFP server 101 updates the master database, which is managed by the server application 301, with the setting data received from the MFP 102.

The server application 301 of the MFP server 101 also backs up management target setting data to a backup destination set in advance. In the present embodiment, the MFP server 101 performs replication of management target setting data. Replication is a technology to make a copy (backup data) of a master database, which is managed by a certain computer, to another computer, and when the master database has been updated, automatically reflect the update on the backup data.

In the present embodiment, the MFPs 102 and 103 as well as the MFP 101 have a client application and a server application. To run the MFPs 102 and 103 as only clients for the MFP server 101, a user is allowed to disable the server applications of the MFPs 102 and 103. However, the MFP 102 may be caused to function as a client for the MFP server 101, and the MFP 102 may be caused to function as a server for another apparatus (such as an MFP), not shown. In this case, the server application and the client application are enabled in the MFP 102.

A description will now be given of a configuration of hardware in the MFP server 101 and the MFPs 102 and 103. It should be noted that in the present embodiment, the MFP server 101 and the MFPs 102 and 103 have the same configuration, and therefore, the following description uses the MFP server 101 as an example.

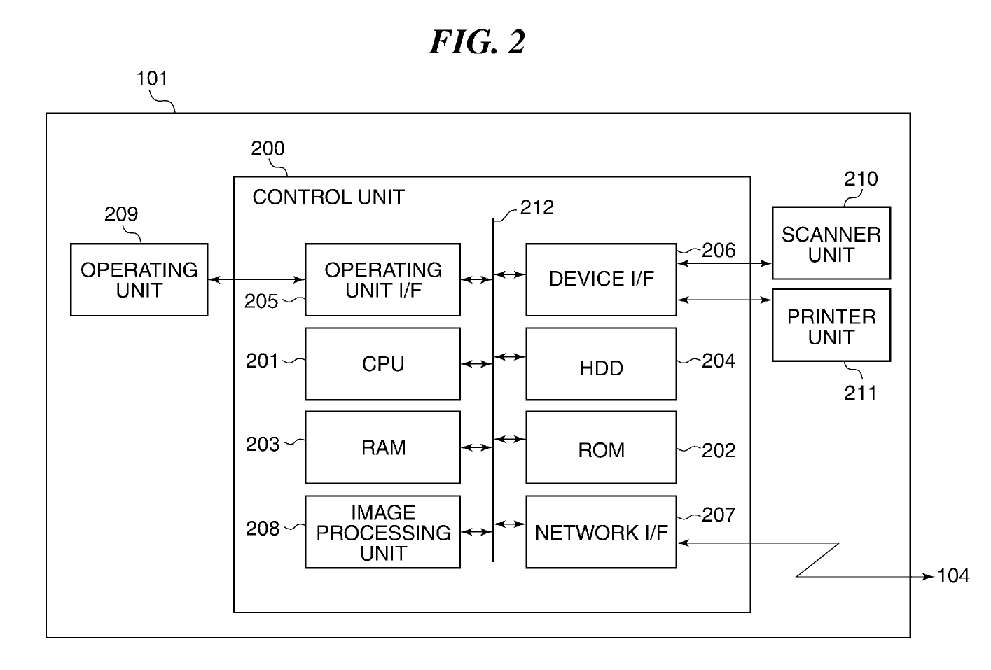

FIG. 2 is a block diagram schematically showing a configuration of hardware in the MFP server 101 in FIG. 1.

Referring to FIG. 2, the MFP server 101 has a control unit 200, an operating unit 209 (display control means), a scanner unit 210, and a printer unit 211. The control unit 200 is connected to the operating unit 209, the scanner unit 210, and the printer unit 211. The control unit 200 has a CPU 201, a ROM 202, a RAM 203, an HDD 204, an operating unit OF 205, a device OF 206, a network OF 207, and an image processing unit 208. The component elements comprised of the CPU 201, the ROM 202, the RAM 203, the HDD 204, the operating unit OF 205, the device OF 206, the network OF 207, and the image processing unit 208 are connected to one another via a system bus 212.

The control unit 200 centrally controls the entire MFP server 101. By executing programs stored in the ROM 202, the CPU 201 carries out processes of a software module 300 in FIG. 3, to be described later, to control the component elements connected to the system bus 212. The ROM 202 stores, for example, programs that are to be executed by the CPU 201. The RAM 203 is used as a work area for the CPU 201 and also used as a temporary storage area for a variety of data. The HDD 204 stores a variety of data, programs, and so forth. The operating unit OF 205 carries out data communications with the operating unit 209, and the device OF 206 carries out data communications with the scanner unit 210 and the printer unit 211. The network OF 207 carries out data communications with the MFPs 102 and 103 and others connected to the network OF 207 via the network 104. The image processing unit 208 subjects image data, which is generated by the scanner unit 210, to image processing such as image rotation, image compression, resolution conversion, color space conversion, and gray scale conversion. The operating unit 209 has a display unit and operating keys, not shown, and the display unit displays a setting screen on which a variety of settings are configured. The operating unit 209 receives input information input through operation on the operating keys by a user. The scanner unit 211 reads an original placed on an original platen glass, not shown, and generates image data. The printing unit 211 performs printing based on image data generated by the scanner unit 210 or the like.

FIG. 3 is a block diagram schematically showing a configuration of the software module 300 of the MFP server 101 in FIG. 1.

Referring to FIG. 3, the software module 300 has a server application 301, a data management module 306, and the client application 307. The server application 301 has a sending and receiving module 302, a control module 303, an analyzing module 304, and a data processing module 305. Processes of the software modules 300 are carried out by the CPU 201 of the MFP server 101 executing programs stored in the ROM 202 and the HDD 204.

The server application 301 controls execution of processes carried out by a server in the communication system 100 and manages management target setting data. In the present embodiment, the server application 301 manages device basic data, device setting data, and personalized data on each management target apparatus as the management target setting data. The device basic data is setting data including information on an identification number, a version, etc. of the management target apparatus. The device setting data is setting data on network settings and printer operations of the management target apparatus. The personalized data is setting data on display languages, shortcut buttons, and so forth personalized for users who use the management target apparatus. The sending and receiving module 302 controls data communications with the MFPs 102 and 103, which are carried out in a management target setting data synchronization process and a management target setting data backup process. The control module 303 controls processes of the sending and receiving module 302, the analyzing module 304, and the data processing module 305. The analyzing module 304 analyzes, for example, notifications of requests for processes obtained from the MFPs 102 and 103. The data processing module 305 carries out a management target setting data management process, and more specifically, adds, deletes, updates, and transfers management target setting data. The data management module 306 manages a database including management target setting data, and the database including the management target setting data is stored in the RAM 203, the HDD 204, or the like. The client application 307 controls communication of request notifications when the MFP 101 acting as a client requests the MFP server 101 to, for example, register the management target apparatus or synchronize management target setting data.

A description will now be given of a configuration of software in the MFPs 102 and 103. It should be noted that in the present embodiment, the software in the MFPs 102 and 103 have the same configuration, and therefore, the following description uses the MFP 102 as an example.

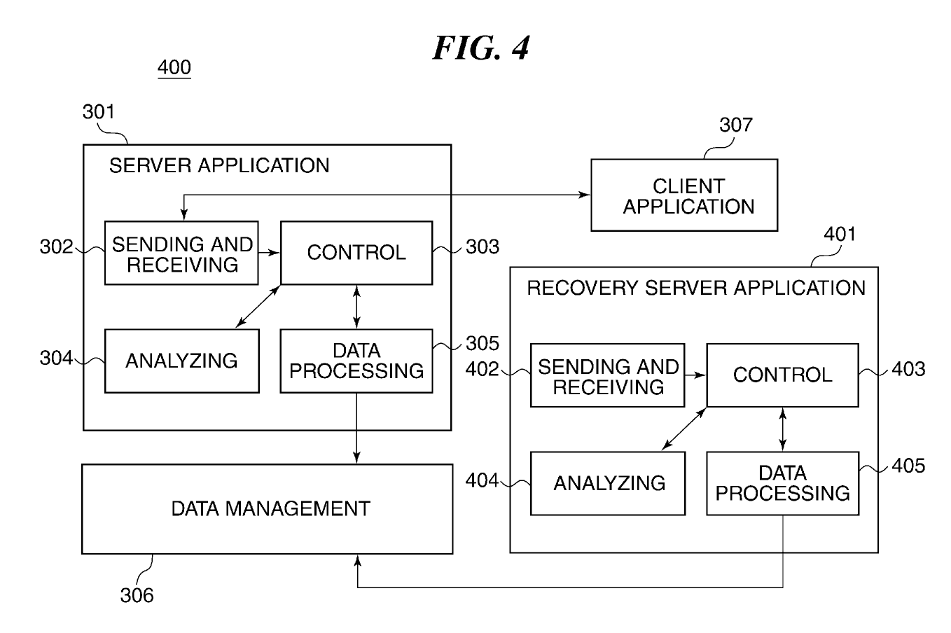

FIG. 4 is a block diagram schematically showing a configuration of a software module 400 of the MFP 102 in FIG. 1.

Referring to FIG. 4, the software module 400 has a recovery server application 401 as well as the server application 301, the data management module 306, and the client application 307 in FIG. 3. The recovery server application 401 has a sending and receiving module 402, a control module 403, an analyzing module 404, and a data processing module 405. Processes of the software modules 400 are carried out by the CPU 201 of the MFP 102 executing programs stored in the ROM 202 and the HDD 204.

The recovery server application 401 controls, for example, a management target setting data accepting process when the MFP 102 is set as a backup destination for management target setting data. The sending and receiving module 402 controls sending and receiving of recovery server application 401 to and from the MFP server 101. The control module 403 controls processes of the sending and receiving module 402, the analyzing module 404, and the data processing module 405. The analyzing module 404 analyzes notifications received from the MFP server 101. The data processing module 405 carries out a management process for management target setting data received by the sending and receiving module 402, and more specifically, adds, deletes, updates, and transfers management target setting data. The data management module 306 manages a database including management target setting data, and stores the database in the RAM 203, the HDD 204, or the like.

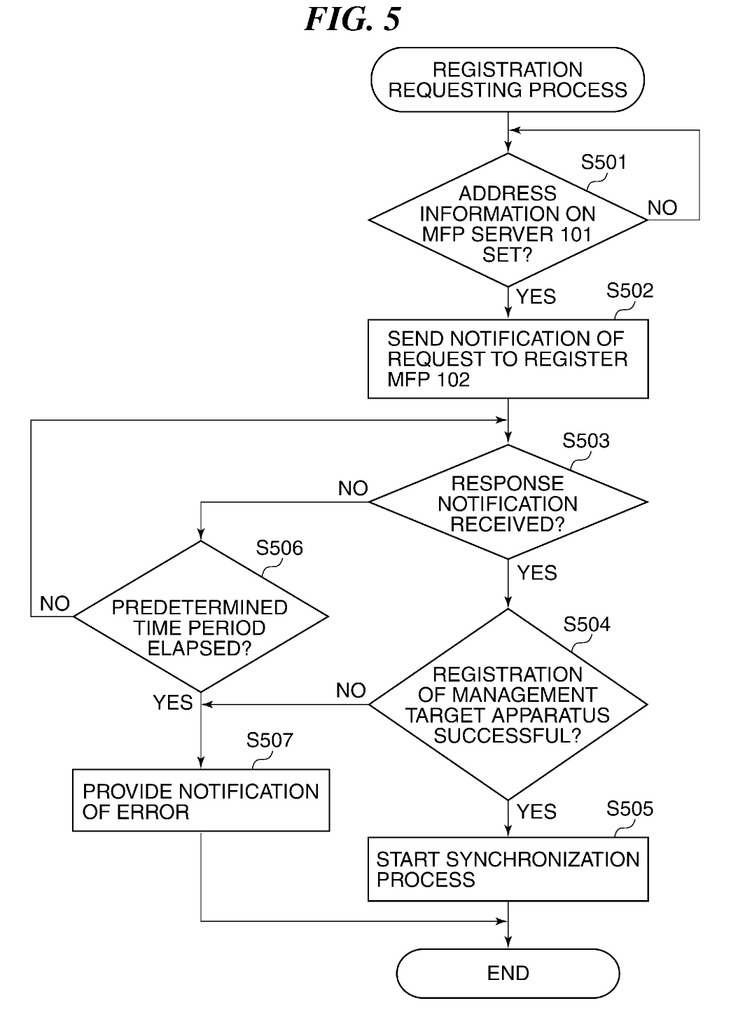

Referring next to FIGS. 5 to 8, a description will be given of how the management target apparatus in the communication system 100 is registered. FIG. 5 is a flowchart showing the procedure of a registration requesting process which is carried out by the MFP 102 in FIG. 1. The process in FIG. 5 is carried out by the client application 307. In the following description, it is assumed that the process is carried out in the MFP 102, but the client application 307 in the MFPs 101 and 103 as well operate in the same manner.

When the client application 307 is enabled, the MFP 102 identifies a server to which it should connect and address information on the server. For example, the MFP 102 is able to identify address information on a server by referring to the address information on the server set in advance in the MFP 102.

Alternatively, the MFP 102 is able to broadcast a packet for searching the server to the network 104, identify a server by checking a response to the packet, and identify address information on the server.

Here, in the present embodiment, each of the MFPs 101 to 103 acting as clients may identify itself as a server when the server application 301 of its own is enabled. Each of the MFPs 101 to 103 acting as clients determines whether or not the server application 301 of its own is enabled, and when the server application 301 of its own is enabled, determines itself as a possible server to which it should connect. Each of the MFPs 101 to 103 identifies itself as a server when the server application 301 of its own is enabled, and no server on the network 104 is detected. Each of the MFPs 101 to 103 is allowed to identify a server based on a user's choice when any server other than itself is identified.

Upon identifying address information on the MFP server 101 (YES in step S501), the MFP 102 sends a registration request notification, which requests registration of the management target apparatus, to the MFP server 101 (step S502).

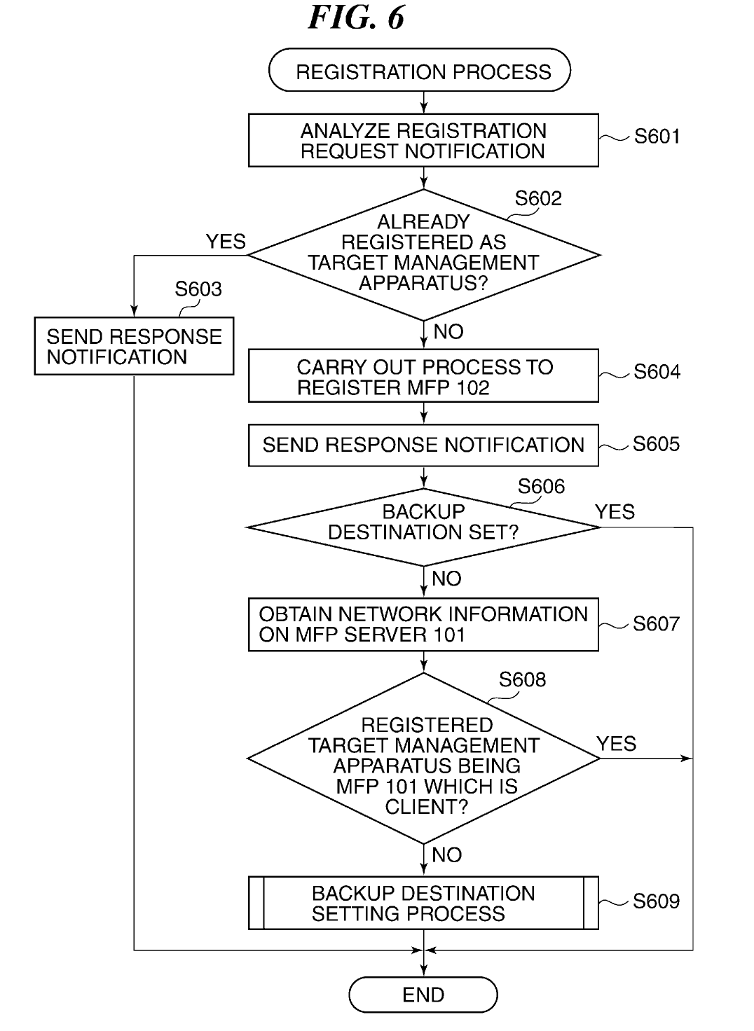

The registration request notification includes an identifier of the MFP 102, network address information on the MFP 102, a name of the MFP 102, information indicative of a location at which the MFP 102 is placed, device configuration information, and device information such as information on licenses and installed applications. Upon receiving the registration request notification, the MFP server 101 carries out a registration process in FIG. 6, to be described later.

Then, the MFP 102 determines whether or not it has received a response notification from the MFP server 101 in response to the registration request notification (step S503). As a result of the determination in the step S503, when the MFP 102 has received the response notification, it analyzes the response notification, and based on a result of the analysis, determines whether or not the MFP 102 has been registered in the MFP server 101, that is, whether or not the management target apparatus has been successfully registered (step S504). In the step S504, when the response notification indicates that the MFP 102 has been registered as a new management target apparatus, the MFP 102 determines that the management target apparatus has been successfully registered. On the other hand, when the response notification does not indicate that the MFP 102 has been registered as a new management target apparatus, the MFP 102 determines that the management target apparatus has not been successfully registered.

As a result of the determination in the step S504, when the management target apparatus has not been successfully registered, the MFP 102 carries out a process in step S507, to be described later. On the other hand, as a result of the determination in the step S504, when the management target apparatus has been successfully registered, the MFP 102 starts a synchronization process in which it synchronizes setting data on the MFP 102 with management target setting data (step S505) and ends the present process.

As a result of the determination in the step S503, when the MFP 102 has not received the response notification, it determines whether or not a predetermined time period set in advance has elapsed since it sent the registration request notification (step S506).

As a result of the determination in the step S506, when the predetermined time period has not elapsed since the MFP 102 sent the registration request notification, the process returns to the step S503. On the other hand, as a result of the determination in the step S506, when the predetermined time period has elapsed since the MFP 102 sent the registration request notification, the MFP 102 provides notification of an error (step S507) and ends the present process.

FIG. 6 is a flowchart showing the procedure of a registration process which is carried out by the MFP server 101 in FIG. 1. In the present embodiment, the process in FIG. 6 is implemented by the server application 301. The process in FIG. 6 is carried out by the CPU 201 executing a program stored in the ROM 202 or the HDD 204.

Referring to FIG. 6, first, upon receiving the registration request notification, the CPU 201 analyzes the registration request notification (step S601), and based on a result of the analysis, determines whether or not the MFP 102 which is a sender of the registration request notification has already been registered as the management target apparatus (step S602).

It should be noted that between the process in the step S601 and the process in the step S602, a process to perform authentication of a client that sent the registration request notification may be carried out. The way of authentication is not particularly limited. When authentication of the client that sent the registration request notification has been successful, the process proceeds to the step S602, and when the authentication has been unsuccessful, the process proceeds to the step S603.

Returning to the description of the process in the step S602, as a result of the determination in the step S602, when the MFP 102 has already been registered as a management target apparatus, the CPU 201 sends a response notification, which indicates that a registration process will not be carried out because the MFP 102 has already been registered, to the MFP 102 (step S602) and ends the present process. On the other hand, as a result of the determination in the step S602, when the MFP 102 has not yet been registered as a management target apparatus, the CPU 201 carries out a process to register the MFP 102 (step S604).

Next, when the process to register the MFP 102 has been completed, the CPU 201 sends a response notification, which indicates that the MFP 102 has been registered as a new management target apparatus, to the MFP 102 (step S605). Then, the CPU 201 determines whether or not a backup destination of management target setting data stored in the MFP server 101 has been set (step S606).

It should be noted that before carrying out the process in the step S606, the CPU 201 may check if a license to perform backup has been enabled in the MFP server 101. Also, before carrying out the process in the step S606, the CPU 201 may carry out a process in which it checks a user setting as to whether or not to enable a backup function. When the license to perform backup has been enabled, or when the user setting to enable the backup function has been configured, the process proceeds to step S607, and otherwise, the process is brought to an end.

As a result of the determination in the step S606, when a backup destination of the management target setting data stored in the MFP server 101 has been set, the CPU 201 ends the present process. On the other hand, as a result of the determination in the step S606, when a backup destination of management target setting data stored in the MFP server 101 has not been set, the CPU 201 obtains network information on the MFP server 101 itself (step S607). Then, based on the obtained network information, the CPU 201 determines whether or not the registered management target apparatus is the MFP 101 which acting as a client (step S609). The case where the registered management target apparatus is the MFP 101 acting as a client means a case where the MFP 101 acting as a client identified the MFP server 101 as a server and sent the registration request notification to the MFP server 101.

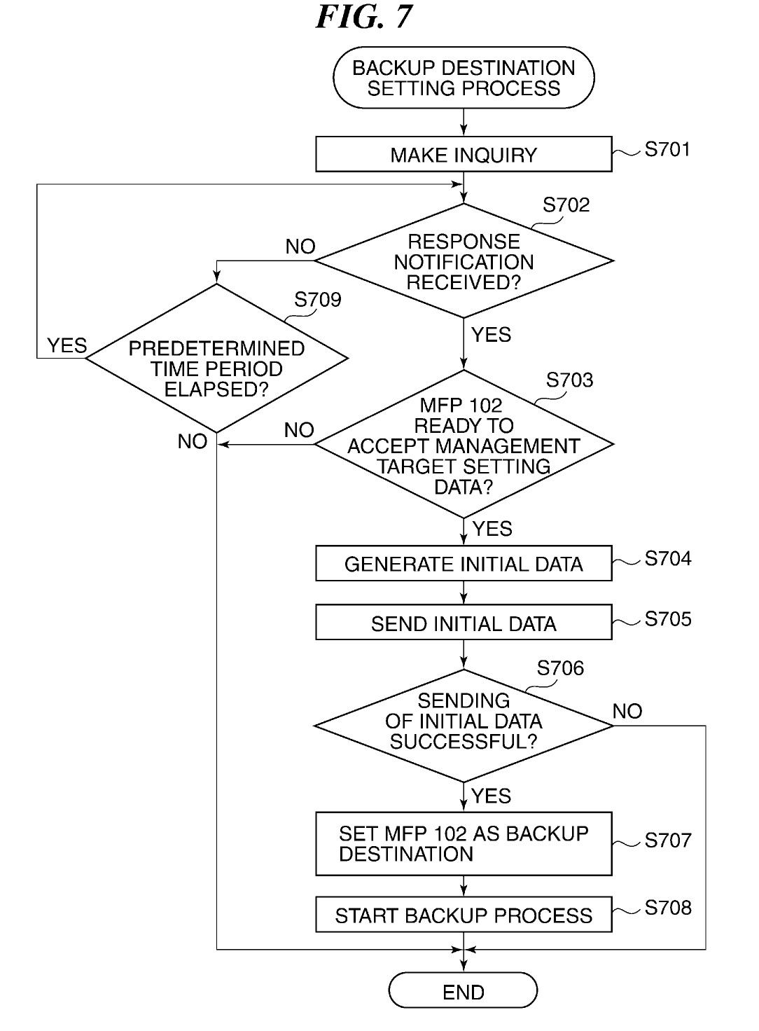

As a result of the determination in the step S608, when the registered management target apparatus is the MFP 101 acting as a client, the CPU 201 ends the present process. Namely, when a client that provided the registration request notification is the client itself, the client is controlled so as not to be a backup destination. This prevents management target setting data managed by a server from being backed up to the server itself. On the other hand, as a result of the determination in the step S608, when the registered management target apparatus is not the MFP 101 acting as a client, the CPU 201 sets a backup destination by carrying out a backup destination setting process in FIG. 7, to be described later (step S609) and ends the present process. The management target setting information is thus backed up to the MFP 102. Therefore, even when the MFP 101 stops operating due to maintenance or failure, operation of the system is continued by taking out backup data from the MFP 102.

FIG. 7 is a flowchart showing the procedure of the backup destination setting process in the step S609 in FIG. 6.

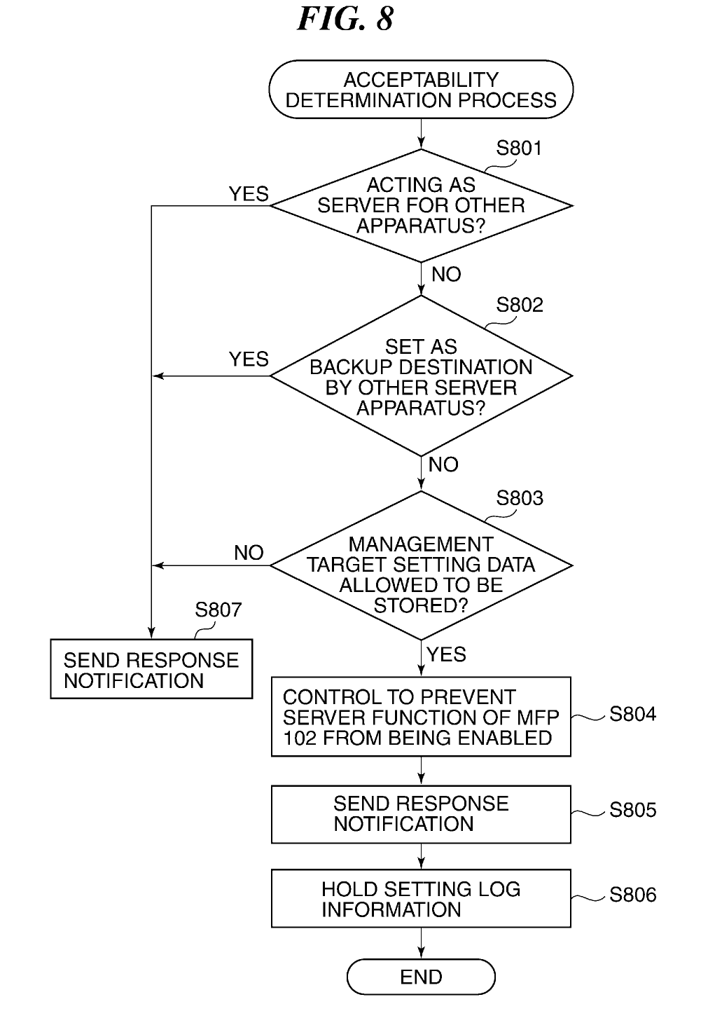

Referring to FIG. 7, first, the CPU 201 inquires of the MFP 102 as to whether or not the MFP 102 is able to accept the management target setting data (step S701). Upon receiving the inquiry, the MFP 102 carries out an acceptability determination process in FIG. 8, to be described later. Next, the CPU 201 determines whether or not a response notification has been received from the MFP 102 in response to the inquiry (step S702).

As a result of the determination in the step S702, when the response notification has been received from the MFP 102, the CPU 201 analyzes the response notification. Then, based on a result of the analysis, the CPU 201 determines whether or not the MFP 102 is able to accept management target setting data (step S703).

As a result of the determination in the step S703, when the MFP 102 is not able to accept management target setting data, the CPU 201 ends the present process. How to determine whether or not the MFP 102 is able to accept management target setting data will be described later with reference to FIG. 8. On the other hand, as a result of the determination in the step S703, when the MFP 102 is able to accept management target setting data, the CPU 201 generates initial data based on stored management target setting data (step S704). The initial data is, for example, part of setting data of the management target setting data or log information on the management target setting data. After that, the CPU 201 sends the initial data to the MFP 102 (step S705), and upon receiving a notification of receipt of the initial data from the MFP 102, the CPU 201 determines, based on the notification of receipt, whether or not a sending process for the initial data has been successful (step S706).

As a result of the determination in the step S706, when the sending process for the initial data has been unsuccessful, the CPU 201 ends the present process. On the other hand, as a result of the determination in the step S706, when the sending process for the initial data has been successful, the CPU 201 sets the MFP 102 as a backup destination (step S707) and sends a notification, which indicates that the MFP 102 has been set as the backup destination, to the MFP 102. Then, the CPU 201 stats the management target setting data backup process (step S708).

In the present embodiment, as described above with reference to FIG. 6 and FIG. 7, when conditions described below are satisfied, the MFP server 101 sets a backup destination of management target setting data and backs up the management target setting data. Examples of the conditions are that (1) a backup destination of management target setting data has not been set in the MFP server 101, (2) a registration request notification has been received from a client apparatus other than the MFP 101, and (3) a client (other than the MFP 101 itself) that sent a registration request notification backup data is able to accept backup data. After the backup, the CPU 201 ends the present process.

As a result of the determination in the step S702, when the response notification has not been received from the MFP 102, the CPU 201 determines whether or not a predetermined time period set in advance has elapsed since the inquiry (step S709).

As a result of the determination in the step S709, when the predetermined time period set in advance has not elapsed since the inquiry, the process returns to the process in the step S702. On the other hand, as a result of the determination in the step S709, when the predetermined time period set in advance has elapsed since the inquiry, the CPU 201 ends the present process.

FIG. 8 is a flowchart showing the procedure of an acceptability determination process which is carried out by the MFP 102 in FIG. 1.

Referring to FIG. 8, first, the MFP 102 determines whether or not its own server application is enabled and running, that is, whether or not the MFP 102 is functioning as a server for another apparatus (step S801). As described above, the MFP 102 may operate as a management target apparatus for the MFP server 101, and at the same time, operate as a server for another apparatus, not shown, as well. In this case, the MFP 102 needs to hold setting data on the MFP 102 itself and also hold master data (management target setting data) including setting data on the other apparatus. Thus, only a small amount of space is left in memory of the MFP 102. For this reason, if the MFP 102 further holds management target setting data, which is managed by the MFP server 101, as backup data, it is undesirable because the storage capacity of the MFP 102 is exceeded or the operation of the MFP 102 becomes unstable. Therefore, when the server function is enabled in the MFP 102, and the MFP 102 is operating as a server for another apparatus as well, the MFP 102 determines that the MFP 102 itself is not suitable as a backup destination.

As a result of the determination in the step S801, when the MFP 102 is functioning as a server for another apparatus, the MFP 102 carries out a process in step S807, to be described later. On the other hand, as a result of the determination in the step S801, when the MFP 102 is not functioning as a server for another apparatus, the MFP 102 determines whether or not the MFP 102 is set as a backup destination by another server apparatus other than the MFP server 101 (step S802). The case where the MFP 102 is not functioning as a server for another apparatus is, for example, a case where the server function of the MFP 102 is disabled.

As a result of the determination in the step S802, when the MFP 102 is set as a backup destination by another server apparatus other than the MFP server 101, the MFP 102 carries out the process in the step S807, to be described later. On the other hand, as a result of the determination in the step S802, when the MFP 102 is not set as a backup destination by another server apparatus other than the MFP server 101, the MFP 102 determines whether or not it is able to store management target setting data (step S803). In the step S803, for example, when it is possible to reserve a free space the amount of which is equal to or larger than the data amount of the management target setting data, the MFP 102 determines that it is able to store the management target setting data. On the other hand, when it is impossible to reserve a free space the amount of which is equal to or larger than the data amount of the management target setting data cannot be reserved, the MFP 102 determines that it is not able to store the management target setting data.

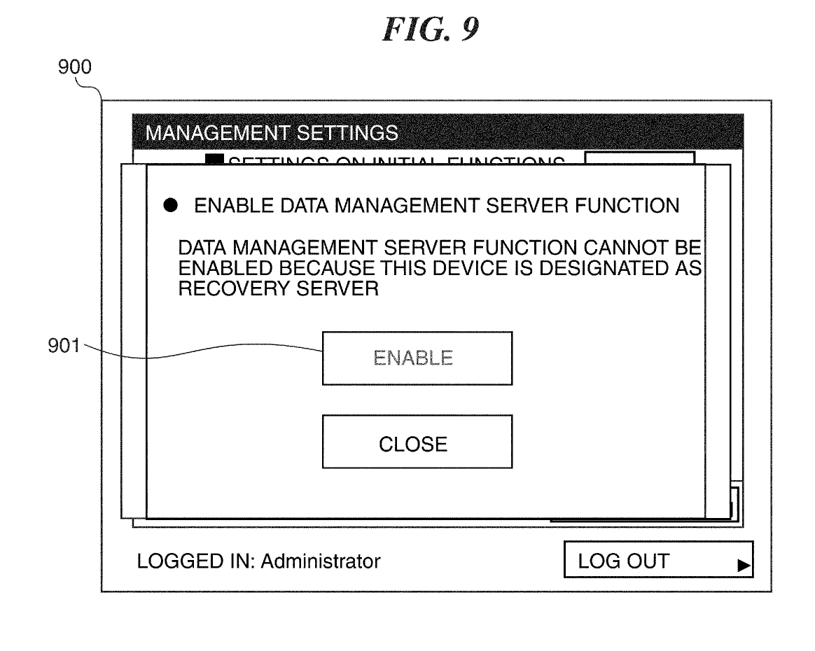

As a result of the determination in the step S803, when the MFP 102 is able to store the management target setting data, the MFP 102 carries out a process to notify the MFP 101 that the MFP 102 is able to be set as a backup destination for the MFP 101. When the MFP 102 becomes a server for another apparatus after the MFP 102 is set as a backup destination, the free space in memory of the MFP 102 is reduced, which may cause a failure. Thus, the MFP 102 provides control such that the server function of the MFP 102 cannot be enabled (step S804). For example, as a setting screen on which a setting as to the server function of the MFP 102 is configured, a setting screen 900 as shown in FIG. 9 is displayed on the operating unit 209. On the setting screen 900, a setting button 901 for setting the MFP 102 as a server in the communication system 100 is disabled, and more specifically, the setting button 901 is displayed such that it cannot be selected by a user. It should be noted that to prevent the server function of the MFP 102 from being enabled, control may be provided such that the setting button 901 is not displayed.

Then, the MFP 102 sends the response notification, which indicates that it is able to accept management target setting data, to the MFP server 101 (step S805). After that, upon receiving the notification that the MFP 102 has been set as a backup destination from the MFP server 101, the MFP 102 holds setting log information indicating that the MFP 102 has been set as a backup destination for the MFP server 101 (step S806) and ends the present process.

As a result of the determination in the step S803, when the MFP 102 is not able to store the management target setting data, the MFP 102 sends the response notification, which indicates that it does not accept management target setting data, to the MFP server 101 (step S807) and ends the present process.

According to the embodiment described above, backup data of management target setting data managed by the MFP server 101 is backed up to an apparatus other than the MFP server 101 itself. Therefore, even when the MFP server 101 stops operating due to maintenance or failure, operation of the system is continued by taking out the backup data from the backup destination.

Next, as a second embodiment of the present invention, a description will now be given of an example where the MFP 102 operating as a backup destination plays a role as a server as a replacement for the MFP 101 when the MFP server 101 stops operating due to maintenance or failure. Since the MFP 102, which is the backup destination, acts as a replacement server, operation of the communication system 100 is more smoothly continued.

A system configuration and arrangements of the apparatuses in the present embodiment are the same as those in the first embodiment, and therefore, description thereof is omitted.

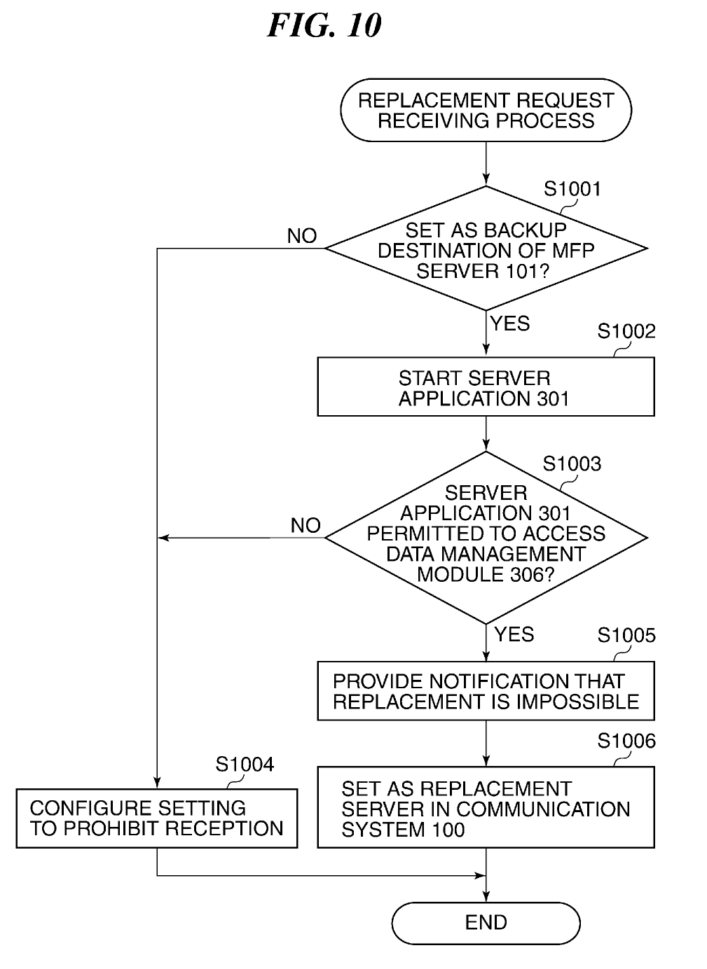

FIG. 10 is a flowchart showing the procedure of a replacement request receiving process which is carried out by the MFP 102 in FIG. 1.

Referring to FIG. 10, first, upon receiving a replacement request notification, which requests replacement of a server in the communication system 100, from the MFP server 101, the MFP 102 determines whether or not the MFP 102 is set as a backup destination for the MFP server 101 (step S1001).

As a result of the determination in the step S1001, when the MFP 102 is not set as the backup destination for the MFP server 101, the MFP 102 carries out a process in step S1004, to be described later. On the other hand, as a result of the determination in the step S1001, when the MFP 102 is set as the backup destination for the MFP server 101, the MFP 102 starts the server application 301 (step S1002). Next, the MFP 102 determines whether or not the server application 301 is permitted to access the data management module 306 (step S1003).

As a result of the determination in the step S1003, when the server application 301 is not permitted to access the data management module 306, the MFP 102 notifies the MFP server 101 that the MFP 102 is not able to act as a replacement server (step S1004). After that, the MFP 102 ends the present process.

As a result of the determination in the step S1003, when the server application 301 is permitted to access the data management module 306, the MFP 102 notifies the MFP server 101 that the MFP 102 is able to act as the replacement server (step S1004). Then, the MFP 102 makes such a setting as not to accept a request to set the MFP 102 as a backup destination (step S1005). After that, the MFP 102 sets the MFP 102 itself as the replacement server in the communication system 100 (step S1006).

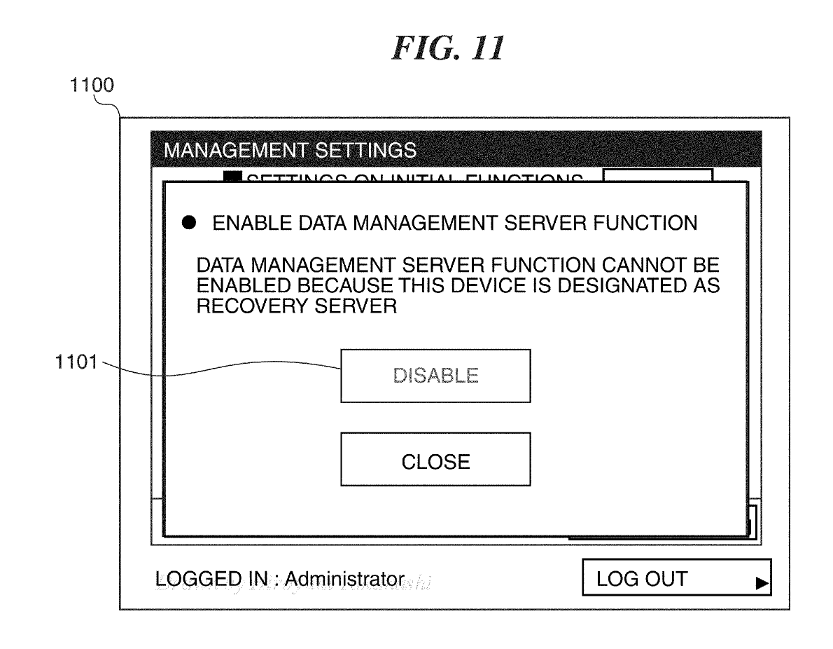

In the step S1006, even when the setting button 901 on the setting screen 900 is displayed such that it cannot be selected, the MFP 102 sets the MFP 102 itself as the replacement server in the communication system 100 based on the replacement request notification from the MFP server 101. As a result of the process in the step S1006, the server authority for the communication system 100 is shifted from the MFP server 101 to the MFP 102, and the MFP 102 starts acting as the replacement server to carry out a process to manage management target setting data. In the present embodiment, when the MFP 102 is set as the replacement server in the communication system 100, a setting screen 1100 in FIG. 11 is displayed on the operating unit 209 as a setting screen for configuring a settings as to the server function of the MFP 102. The setting screen 1100 includes a notification that the MFP 102 is operating as the replacement server, and a setting button 1101 for setting the MFP 102 as a server is displayed such that it cannot be selected by a user. After that, the MFP 102 ends the present process.

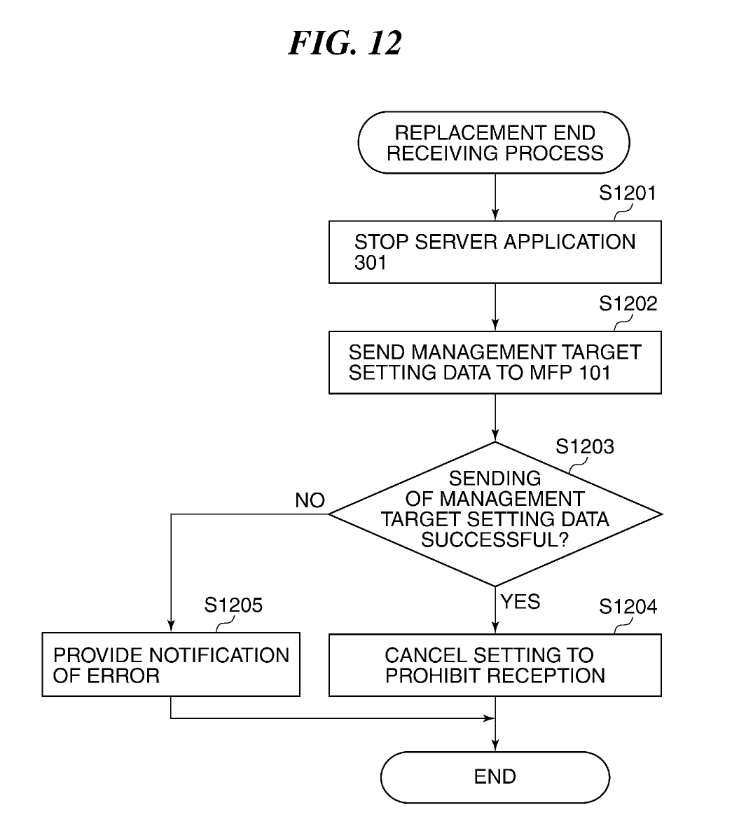

FIG. 12 is a flowchart showing the procedure of a replacement end receiving process which is carried out by the MFP 102 in FIG. 1.

Referring to FIG. 12, first, upon receiving a replacement ending request notification, which requests termination of server replacement, from the MFP 101, the MFP 102 which has been the replacement server stops the server application 301 (step S1201). Next, the MFP 102 sends management target setting data to the MFP 101 using the recovery server application 401 (step S1201) and determines whether or not sending of the management target setting data has been successful (step S1203).

As a result of the determination in the step S1203, when sending of the management target setting data has been successful, the MFP 102 cancels the setting made in the step S1005 in FIG. 10 that the request cannot be accepted (step S1204). As a result, the server authority in the communication system 100 is shifted from the MFP 102 to the MFP 101, which in turn starts a process to manage the management target setting data. After that, the MFP 102 ends the present process. On the other hand, as a result of the determination in the step S1203, when sending of the management target setting data has been unsuccessful, the MFP 102 notifies the MFP 101 of an error (step S1205) and ends the present process.

According to the processes in FIGS. 5 to 8, 10, and 12 described above, when a management target apparatus registered in the MFP server 101 is not the MFP server 101, the MFP 102 is set as a backup destination management target setting data. Thus, the management target setting data is not sent to the MFP server 101, and hence even if the MFP server 101 is stopped, there will be no situation where the management target setting data is unavailable. As a result, even when the MFP server 101 stops, the management target setting data is available, and this prevents the management target setting data from being continuously unavailable.

Moreover, according to the processes in FIGS. 5 to 8, 10, and 12 described above, when setting of the MFP 102 as a server is not permitted, the setting button 901 for setting the MFP 102 as a server is disabled. This reliably prevents the MFP 102, which is not permitted to be set as a server, from being set as a server due to a user's operating error.

Although the present invention has been described using the first and second embodiments, the present invention is not limited to the embodiments described above.

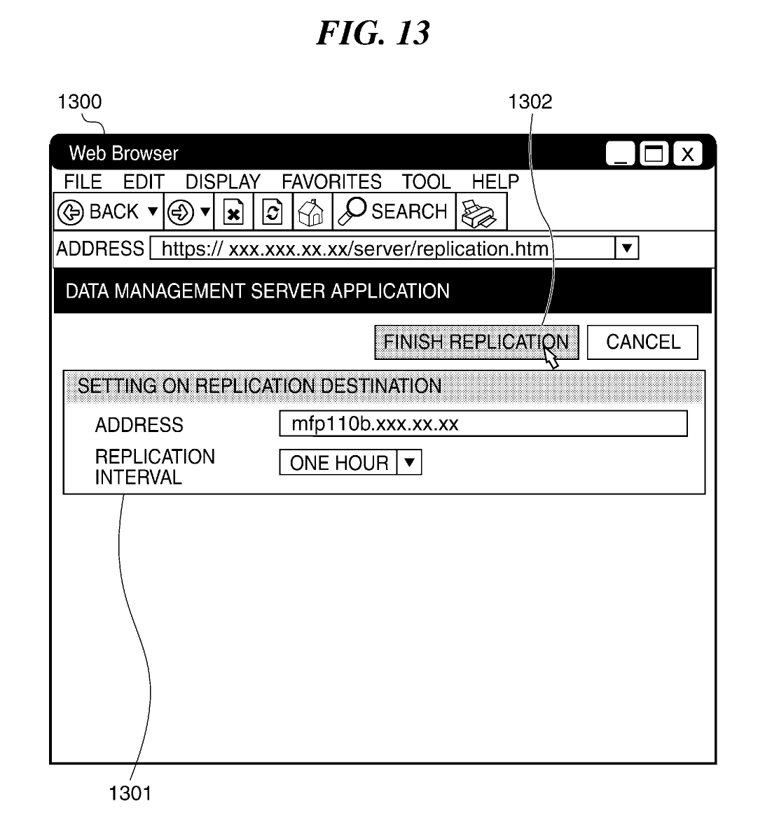

For example, after a backup destination is automatically set in the step S707 in FIG. 7, the user may change the backup destination. The user is allowed to see the backup destination, which was set in the step S707, on a setting screen 1300 in FIG. 13 which is displayed on the operating unit 209 of the MFP server 101. The setting screen 1300 includes settings 1301 on the backup destination and an operating button 1302. The settings 1301 on the backup destination are comprised of address information on the management target apparatus, which is the backup destination, and backup interval information, and the operating button 1302 is for issuing an instruction to terminate backup.

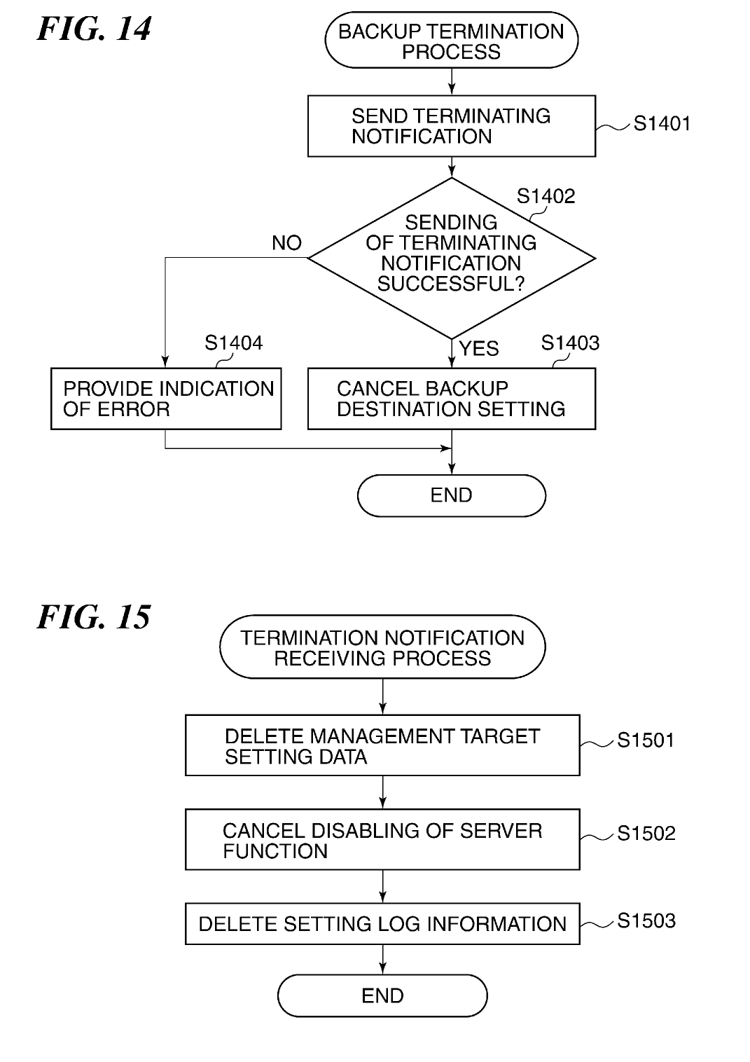

FIG. 14 is a flowchart showing the procedure of a backup termination process which is carried out by the MFP server 101 in FIG. 1.

The process in FIG. 14 is carried out by the CPU 201 executing a program stored in the ROM 202 or the HDD 204 and based on the assumption that management target setting data is backed up to the MFP 102 set as a backup destination.

Referring to FIG. 14, first, when instructed to terminate backup to the MFP 102 through operating on the operating button 1302 on the setting screen 1300, the CPU 201 sends a termination notification, which indicates that sending of management target setting data is to be terminated, to the MFP 102 (step S1401). Next, the CPU 201 determines whether or not sending of the termination notification has been successful (step S1402).

As a result of the determination in the step S1402, when sending of the termination notification has been successful, the CPU 201 terminates the backup process and cancels the settings on a backup destination (step S1403) and ends the present process. On the other hand, as a result of the determination in the step S1402, when sending of the termination notification has been unsuccessful, the CPU 201 displays an error on the operating unit 209 of the MFP server 101 (step S1404) and ends the present process.

FIG. 15 is a flowchart showing the procedure of a termination notification receiving process which is carried out by the MFP 102 in FIG. 1.

Referring to FIG. 15, first, upon receiving a termination notification from the MFP server 101, the MFP 102 deletes management target setting data received in the backup process (step S1501). Next, the MFP 102 permits setting of the MFP 102 as a server in the communication system 100 (step S1502), deletes setting log information held in the step S806 in FIG. 8, and ends the present process.

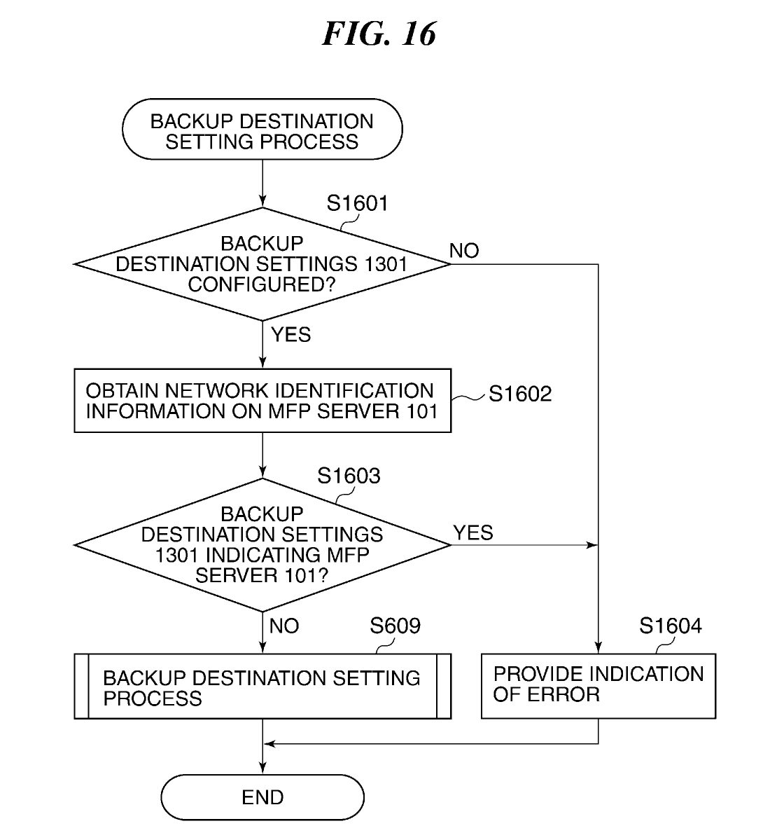

FIG. 16 is a flowchart showing the procedure of a variation of the backup destination setting process in FIG. 7.

The process in FIG. 16 is carried out by the CPU 201 of the MFP server 101 executing a program stored in the ROM 202 or the HDD 204 and based on the assumption that the process in FIG. 15 has been completed. When the process in FIG. 15 is completed, each of the settings 1301 on a backup destination is deleted, and the operating button 1302 is changed to a backup start button, not shown, which is for issuing an instruction to start backup, on the setting screen 1300 displayed on the operating unit 209.

Referring to FIG. 16, first, when the backup start button is selected by the user, the CPU 201 determines whether or not the settings 1301 on a backup destination have been configured (step S1601).

As a result of the determination in the step S1601, when the settings 1301 on a backup destination have not been configured, the CPU 201 carries out a process in step S1604, to be described later. On the other hand, as a result of the determination in the step S1601, when the settings 1301 on a backup destination have been configured, the CPU 201 obtains network information on the MFP server 101 itself (step S1602). Next, based on the obtained network information, the CPU 201 determines whether or not the settings 1301 on the backup destination are those indicative of the MFP server 101(step S1603).

As a result of the determination in the step S1603, when the settings 1301 on the backup destination are those indicative of the MFP server 101, the CPU 201 indicates an error on the operating unit 209 (step S1604) and ends the present process. On the other hand, as a result of the determination in the step S1603, when the settings 1301 on the backup destination are not those indicative of the MFP server 101, the CPU 201 carries out the process in the step S609.

According to the processes in FIGS. 14 to 16 described above, when an instruction to terminate backup of management target setting data is received, setting of the MFP 102 as a server in the communication system 100 is permitted. Also, when the MFP 102 is not set as a backup destination, setting of the MFP 102 as a server in the communication system 100 is permitted. This prevents degradation of operability for users caused by restricting setting of the MFP 102 as a server more than necessary.

Moreover, in the first embodiment or the second embodiment described above, the MFP server 101 may regularly perform backup to the MFP 102 set as a backup destination.

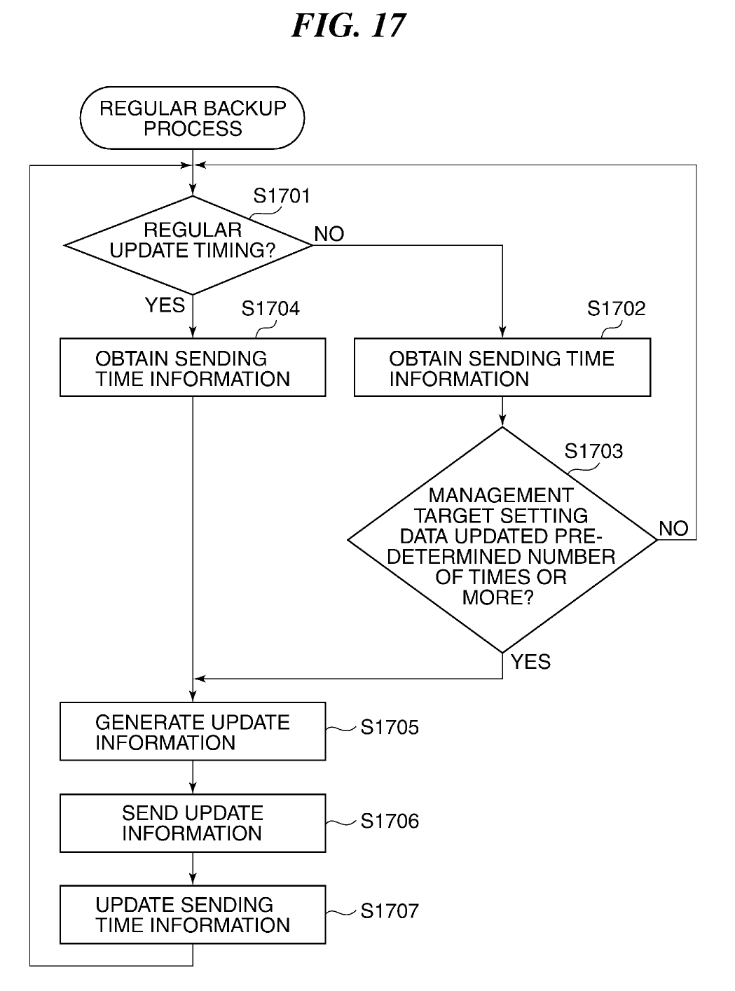

FIG. 17 is a flowchart showing the procedure of a regular backup process which is carried out by the MFP server 101 in FIG. 1.

The process in FIG. 17 is carried out by the CPU 201 of the MFP server 101 executing a program stored in the ROM 202 or the HDD 204 and based on the assumption that a backup destination has been set in the process in FIG. 7 or 16.

Referring to FIG. 17, first, based on a time period measured by a timing unit, not shown, provided in the MFP server 101, the CPU 201 determines whether or not it is the time to perform regular update (step S1701). The time to perform regular update is determined based on predetermined intervals set in advance.

As a result of the determination in the step S1701, when it is the time to perform regular update, the CPU 201 obtains sending time information indicative of a time at which management target setting data was sent to the MFP 102 (step S1702). The sending time information is stored in the ROM 202 or the HDD 204. Then, the CPU 201 determines whether or not the management target setting data sent to the MFP 102 at the time indicated by the sending time information has been updated a predetermined number of times or more (step S1703).

As a result of the determination in the step S1703, when the CPU 201 determines that the management target setting data sent to the MFP 102 at the time indicated by the sending time information has not been updated the predetermined number of times or more, the process returns to the step S1701. On the other hand, as a result of the determination in the step S703, when t the management target setting data sent to the MFP 102 at the time indicated by the sending time information has been updated the predetermined number of times or more, the CPU 201 carries out a process in S1705, to be described later.

As a result of the determination in the step S1701, when it is the time to perform regular update, the CPU 201 obtains sending time information indicative of a time at which management target setting data was sent to the MFP 102 (step S1704). Then, the CPU 201 generates update information including details of updates to the management target setting data (step S1705). After that, the CPU 201 sends the update information to a set backup destination (step S1706) and updates the sending time information based on a time at which the update information was sent (step S1707), followed by the process returning to the step S1701.

Although in the present embodiment described above, the process in the step S1701 and the process in the step S1703 are carried out as sequential processes, the process in the step S1701 and the process in the step S1703 may be carried out as individual processes at the same time.

Moreover, although in the present embodiment described above, whether or not it is the time to perform regular update is determined based on a time period measured by the timing unit, whether or not it is the time to perform regular update should not necessarily be determined based on a time period measured by the timing unit. For example, the MFP 102 set as a backup destination may regularly send the MFP server 101 a notification indicative of whether or not setting data should be updated, and based on the notification, the CPU 201 may determine whether or not it is the time to perform regular update. The notification indicative of whether or not setting data should be updated is provided by, for example, the MFP 102 sending an update information obtaining request to the MFP server 101. When the MFP 101 has obtained update information from an MFP which is a backup destination, the MFP 101 determines that it is the time to perform regular update, and otherwise, determines that it is not the time to perform regular update.

Furthermore, although in the present embodiment described above, only details of updates performed after an update time are sent to a backup destination on a regular basis, all management target setting data may be sent to the backup destination.

Although in the present embodiment described above, the process in the step S1703 and the process in the step S1705 are carried out using update times obtained in the step S1702 and the step S1704 as sequential processes, this is not limitative, but they may be carried out using a method described below.

Specifically, whenever setting data managed by the server application 301 is changed, the MFP 101 generates a change log indicating details of the change and stores the change log in the storage unit. In the step S1705, update information is generated from one or more change logs stored in the storage unit. After the update information is generated, the one or more change logs stored in the storage unit are deleted.

For example, assume that “add setting value A” is stored as a first change log, “delete setting value A” is stored as a second change log stored after the first change log, and “add setting value B” is stored as a third change log in the storage unit. In this case, the MFP server 101 determines that the change “add setting value B” has been made at last as a result of sequential changes indicated by the first change log, the second change log, and the third change log. The MFP server 101 then generates update information indicating that the change “add setting value B” has been made. After that, the MFP server 101 deletes the first change log, the second change log, and the third change log.

Likewise, in the step S1703, when a counted number of change logs stored in the storage unit becomes equal to or greater than a predetermined number of changes, it is determined that changes not less than the number of changes have been made. By carrying out these processes, the process in the step S1703 and the process in the step S1705 are carried out using times of update to backup data.

Although in the present embodiment described above, a backup destination is set upon receipt of a notification that requests registration of the management target apparatus, the time to set a backup destination is not limited to the time when a notification that requests registration of the management target apparatus is received. For example, a backup destination may be set upon receipt of a notification that requests update of registration information on the management target apparatus or upon receipt of a notification that requests obtainment of registration information on the management target apparatus.

Moreover, although in the present embodiment described above, one backup destination is set, the number of backup destinations is not limited to one, but a plurality of backup destinations may be set. When a plurality of backup destinations is to be set, for example, whether or not the number of backup destinations has reached the number of backup destinations set in advance may be determined after the step S605 in the process in FIG. 6. As a result of the determination, when the number of backup destinations has reached the number of backup destinations set in advance, the CPU 201 ends the process in FIG. 6. On the other hand, as a result of the determination, when the number of backup destinations has not reached the number of backup destinations set in advance, the CPU 201 carries out the processes in the step S607 and the subsequent steps.

According to the present invention, continuous use of data managed by a server integral with a client is enabled.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An information processing apparatus acting as a server that manages data on a plurality of clients, comprising,
a storage storing a server application for the server and a client application for a client,
a memory storing instructions related to the server application, and
a processor executing the instructions causing the information processing apparatus to:
receive, from one client of the plurality of clients, a registration request that requests to register the one client as a management target for the server;
transmit, to the one client, a response for the registration;
accumulate data received from the one client as the management target;
determine whether or not the one client that has issued the registration request is a client corresponding to the client application stored in said storage, and
set the one client as a backup destination of the accumulated data, in a case where the backup destination has not been set and it is determined that the one client is not the client corresponding to the client application stored in said storage.

2. The information processing apparatus according to claim 1, wherein the one client is not set as the backup destination, in a case where the backup destination has been set or it is determined that the one client is the client corresponding to the client application stored in said storage.

3. The information processing apparatus according to claim 1, wherein the instructions further cause the information processing apparatus to:
transmit an instruction to terminate backup of the data to the one client as the backup destination, and
cancel the setting of the one client as the backup destination.

4. An information processing apparatus that is registered as a client of a management target by a server on a network, comprising,
a storage storing a client application for the client and a server application for the server,
a memory storing instructions related to the client application, and
a processor executing the instructions causing the information processing apparatus to:
determine whether to permit the information processing apparatus to be set as a backup destination of data accumulated by the server;
perform a control so that the server is not enabled by using the server application stored in the storage, in a case where the information processing apparatus is permitted to be set as the backup destination; and
transmit a notification related to the backup destination to the server on the network.

5. The information processing apparatus according to claim 4, wherein the control is a display control for disabling a setting button for setting the information processing apparatus as the server.

6. The client apparatus according to claim 4, wherein the instructions further cause the information processing apparatus to:
receive an instruction to terminate backup of the data, and
cancel the control in a case where the instruction is received from the server on the network.

7. A backup method for an information processing apparatus acting as a server that manages data on a plurality of clients and includes a storage storing a server application for the server and a client application for a client, the backup method comprising:
receiving, from one client of the plurality of clients, a registration request that requests to register the one client as a management target for the server;
transmitting, to the one client, a response for the registration;
accumulating data received from the one client as the management target;
determining whether or not the one client that has issued the registration request is a client corresponding to the client application stored in said storage, and
setting the one client as a backup destination of the accumulated data, in a case where the backup destination has not been set and it is determined that the one client is not the client corresponding to the client application stored in said storage.

8. A control method for an information processing apparatus that is registered as a client of a management target by a server on a network and includes a storage storing a client application for the client and a server application for the server, the control method comprising:
determining whether to permit the information processing apparatus to be set as a backup destination of data accumulated by the server;
performing a control so that the server is not enabled by using the server application stored in the storage, in a case where the information processing apparatus is permitted to be set as the backup destination; and
transmitting a notification related to the backup destination to the server on the network.

9. A non-transitory computer-readable storage medium storing a program for causing a computer to execute a backup method for an information processing apparatus acting as a server that manages data on a plurality of clients and includes a storage storing a server application for the server and a client application for a client, receiving, from one client of the plurality of clients, a registration request that requests to register the one client as a management target for the server;
transmitting, to the one client, a response for the registration;
accumulating data received from the one client as the management target;
determining whether or not the one client that has issued the registration request is a client corresponding to the client application stored in said storage, and
setting the one client as a backup destination of the accumulated data, in a case where the backup destination has not been set and it is determined that the one client is not the client corresponding to the client application stored in said storage.

10. A non-transitory computer-readable storage medium storing a program for causing a computer to execute a control method for an information processing apparatus that is registered as a client of a management target by a server on a network and includes a storage storing a client application for the client and a server application for the server, the control method comprising:
determining whether to permit the information processing apparatus to be set as a backup destination of data accumulated by the server;
performing a control so that the server is not enabled by using the server application stored in the storage, in a case where the information processing apparatus is permitted to be set as the backup destination; and
transmitting a notification related to the backup destination to the server on the network.
